(19) United States
(12) Patent Application Publication
(10) Pub. No.: US 2012/0020431 A1
(43) Pub. Date: Jan. 26, 2012

(54) ANTENNA DEVICE AND MULTI-ANTENNA SYSTEM

(75) Inventor: Kosuke Tanabe, Tokyo (JP)

(73) Assignee: NEC CORPORATION, Tokyo (JP)

(21) Appl. No.: 13/258,887

(22) PCT Filed: Mar. 16, 2010
(86) PCT No.: PCT/JP2010/054401

§ 371 Date: Sep. 22, 2011

(30) Foreign Application Priority Data
Apr. 16, 2009 (JP) 2009-099867

(51) Int. Cl. H04L 27/26; H01Q 21/28

(52) U.S. Cl. 375/295; 343/893

(57) ABSTRACT

An object of the present invention is to provide an antenna device that exhibits, in wireless communication of an omni-cell system for simultaneously transmitting a plurality of data corresponding to one another, excellent cost performance, and can reduce antenna loss and prevent radio wave interference. This antenna device includes a plurality of sector antennas 11 disposed so that a maximum radial direction where radiation intensity of a radio wave becomes maximum is radially set. The plurality of sector antennas 11 simultaneously transmit a plurality of wireless signals corresponding to one another.

### TECHNICAL FIELD

The present invention relates to an antenna device that simultaneously transmits a plurality of wireless signals corresponding to one another from a plurality of antennas, and a multi-antenna system.

### BACKGROUND ART

For wireless communication, there is a communication system that divides a communication area into a plurality of cells (sections) and locates a base station for each cell. This communication system includes an omini-cell system and a sector cell system. According to the omni-cell system, an omni-antenna that is a nondirectional antenna is installed, and a radio wave is radiated in all directions from this omni-antenna. According to the sector cell system, one cell is divided from a center into a plurality of sector cells, and a sector antenna that is a directional antenna is installed for each sector cell. In other words, the sector cell system enables wireless communication by using one cell for each different sector cell.

In recent years, for the wireless communication, MIMO (Multiple-Input Multiple-Output) has been offered as a technology to increase a transmission capacity or improve transmission reliability. In the MIMO, pluralities of antennas are arranged on both a transmission side and a reception side, and a plurality of wireless signals corresponding to one another are simultaneously transmitted from the plurality of antennas of the transmission side to be received by the plurality of antennas of the reception side. For example, when contents of data indicated by the plurality of wireless signals are different from one another, simultaneous transmission of the wireless signals from the antennas of the transmission side enables an increase of the transmission capacity. When the contents of the data indicated by the plurality of wireless signals are similar, simultaneously transmitting the wireless signals from the antennas of the transmission side to appropriately process the received signals by the reception side enables improvement of transmission reliability.

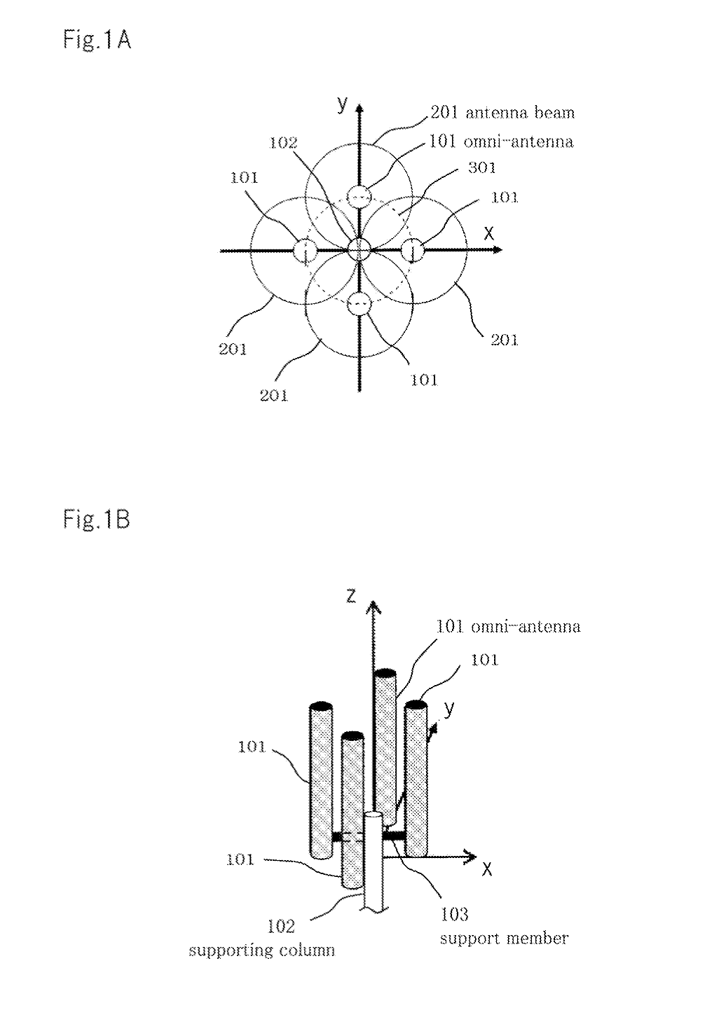

FIGS. 1A and 1B shows an example of an arrangement configuration of omni-antennas used for wireless communication by MIMO. FIG. 1A is a top view showing the example of the arrangement configuration of the omni-antennas, and FIG. 1B is a perspective view showing the example of the arrangement configuration of the omni-antennas. As shown in FIG. 1A, four omni-antennas 101, which constitute a multi-antenna system with a wireless base station device (not shown), are arranged at equal intervals along circle, 301 around supporting column 102. Each omni-antenna 101 is, as shown in FIG. 1B, supported by support member 103 projected from supporting column 102. From each omni-antenna 101, a plurality of wireless signals generated by the wireless base station device and different in data content are simultaneously transmitted by antennal beam 201.

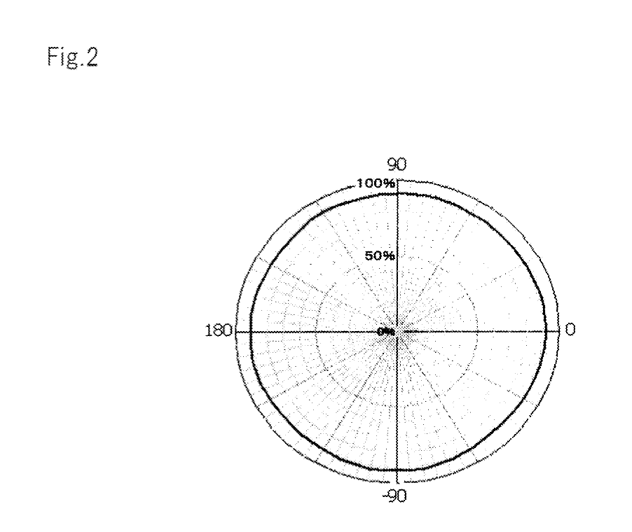

FIG. 2 shows a result of simulating transmission capacity characteristics of the multi-antenna system shown in FIGS. 1A and 1B. FIG. 2 shows the simulation result when a terminal (not shown) including two antennas receives antenna beam 201. A transmission capacity of 100% indicates an ideal theoretical limit value, namely, about 8.1 bps/Hz, when there is no correlation in phase or amplitude between signals received by the two antennas of the terminal. As shown in FIG. 2, when the omni-antenna is used, there are characteristics of only limited fluctuation in transmission capacity in the cell.

In the communication system such as the omni-cell system or the sector cell system where the antenna is installed for each cell, when the phenomenon in which radio waves reach one cell from another cell, namely, overreaching, occurs, if equal frequencies are used between the cells, a problem may occur where radio wave interference is generated in the other cell so as to disable accurate transmission of a wireless signal. As means for preventing such radio wave interference, there are two means, namely, electric tilting and mechanical tilting. Electric tilting is means for adjusting radio wave radiation direction to a depression-angle direction by shifting the power feeding phase by a feeder circuit of a phase shifter included in the antenna, thereby preventing radiation of a radio wave outside the cell. Mechanical tilting is a means for preventing radiation of a radio wave outside the cell by tilting the antenna itself in the depression-angle direction. An antenna device that uses mechanical tilting as radio wave interference prevention means is disclosed in, for example, Patent Literature 1. In the antenna device disclosed in Patent Literature 1, a plurality of antennas are disposed in a state of tilting along a side face of a cone around a vertical direction.

### CITATION LIST

### Patent Literature

Patent Literature 1: JP2001-339237A

### SUMMARY OF INVENTION

### Problems to be Solved

Using electric tilting as radio wave interference prevention means necessitates a complex circuit structure for shifting the power feeding phase by using the feeder circuit. Hence, antenna losses are larger than when mechanical tilting is used, causing a cost increase. In the sector cell system that uses the sector cell antenna, electric tilting and mechanical tilting can both be used as radio wave interference prevention means, and thus the problem can be solved by selecting mechanical tilting. However, in the multi-antenna system of the omni-cell system shown in FIGS. 1A and 1B, the use of the omni-antenna inhibits utilization of mechanical tilting as radio wave interference prevention means. This is because since the omni-antenna radiates uniform radio waves in all directions, when the omni-antenna itself is tilted in the depression-angle direction, a part of the radio waves is radiated in an elevation-angle direction, and this radio wave causes the above-mentioned radio wave interference.

It is therefore an object of the present invention to provide, in wireless communication of an omni-cell system for simultaneously transmitting a plurality of data corresponding to one another, an antenna device that exhibits excellent cost performance, and that can reduce antenna loss and prevent radio wave interference, and a multi-antenna system.

### Solution to Problem

To achieve the object of the present invention, an antenna device includes a plurality of sector antennas arranged so that a maximum radiation direction where radiation intensity of a radio wave becomes maximum is radially set. The plurality of sector antennas simultaneously emit a plurality of wireless signals corresponding to one another.

To achieve the object of the present invention, a multi-antenna system includes the above antenna device, and a wireless base station device connected to the antenna device. The wireless base station device includes a control unit configured to generate the plurality of wireless signals, and a transmission unit configured to simultaneously transmit, under control of the control unit, the plurality of wireless signals individually to the plurality of sector antennas.

### Effects of the Invention

According to the present invention, a wireless communication environment of an omni-cell system can be created in a pseudo manner by using the plurality of sector antennas. The use of the sector antennas enables utilization of mechanical tilting as radio wave interference prevention means. As a result, the antenna device can exhibit excellent cost performance, and prevent radio wave interference with low antenna loss.

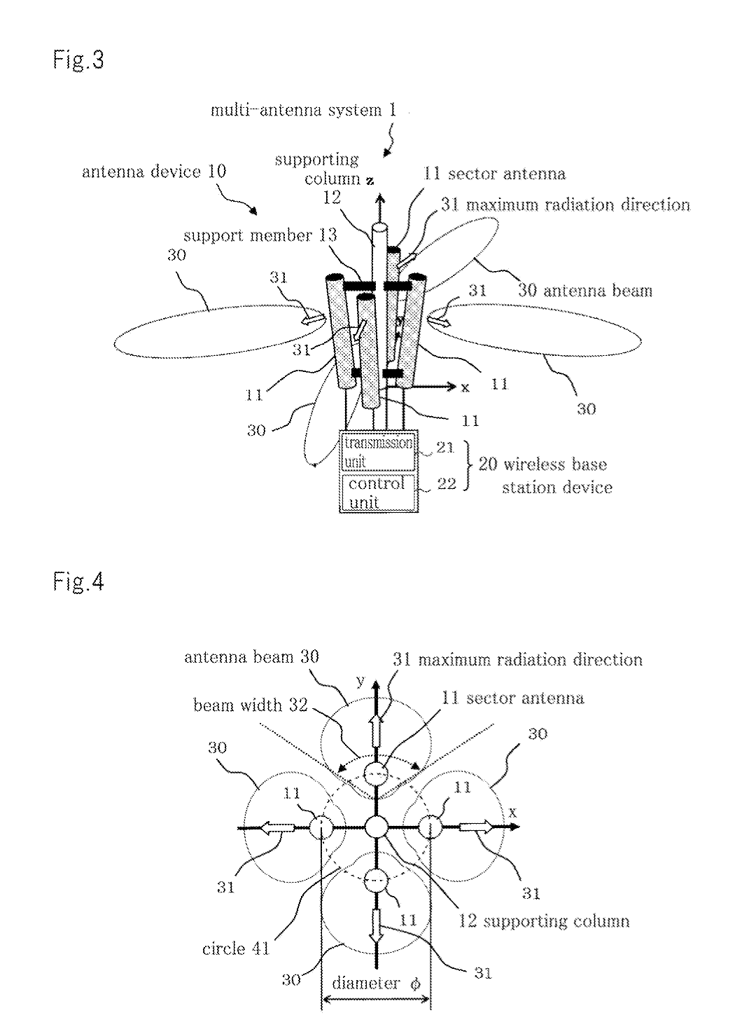

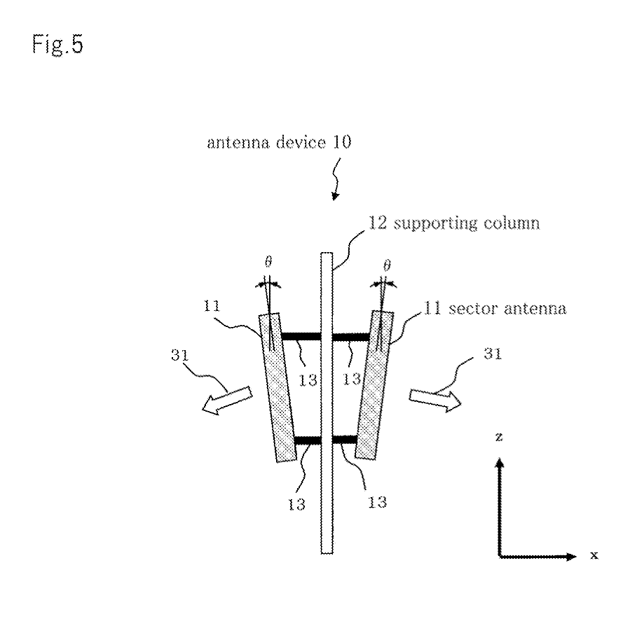

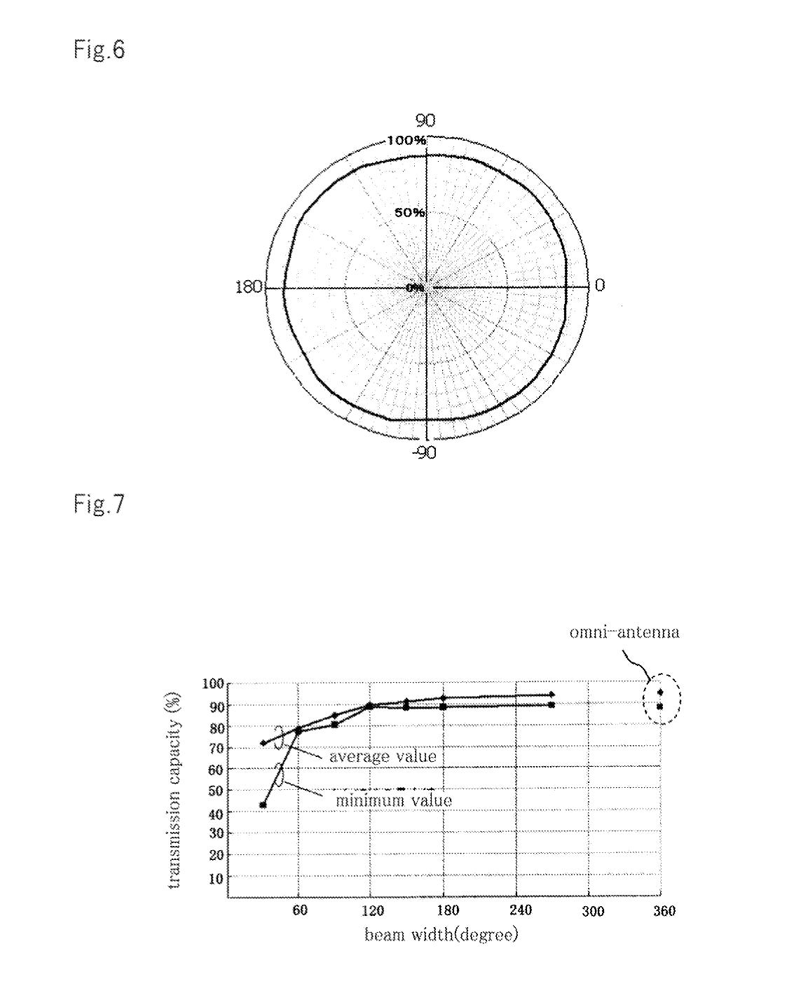

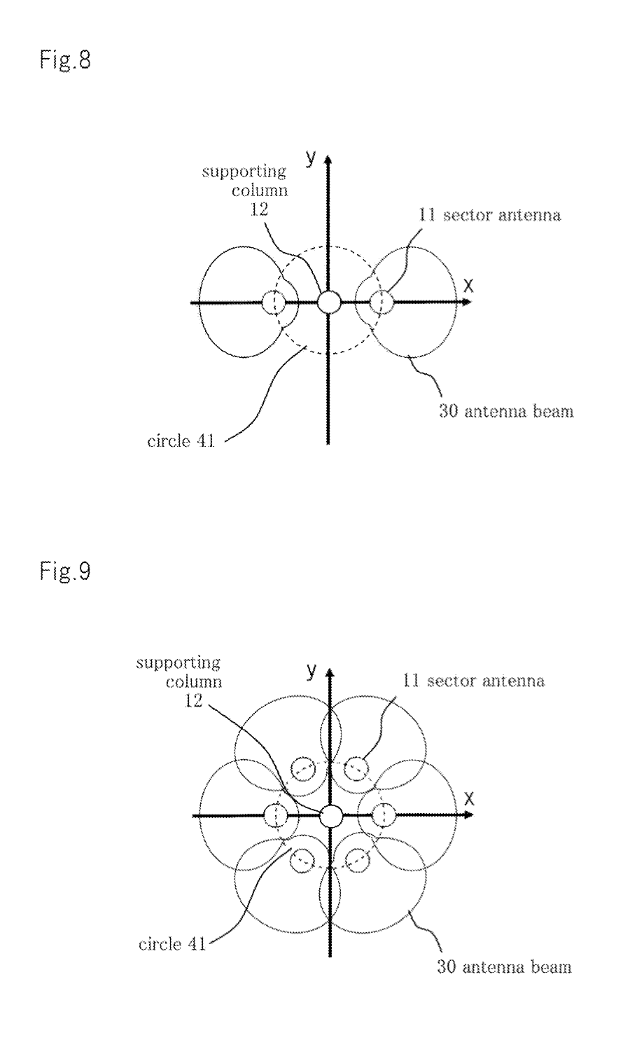

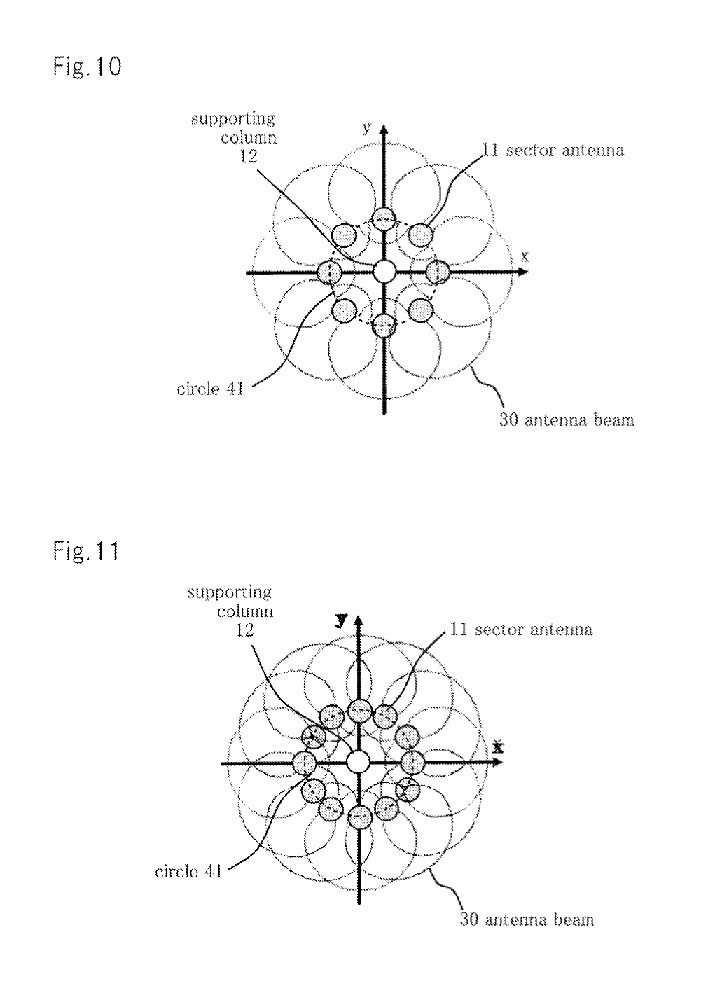

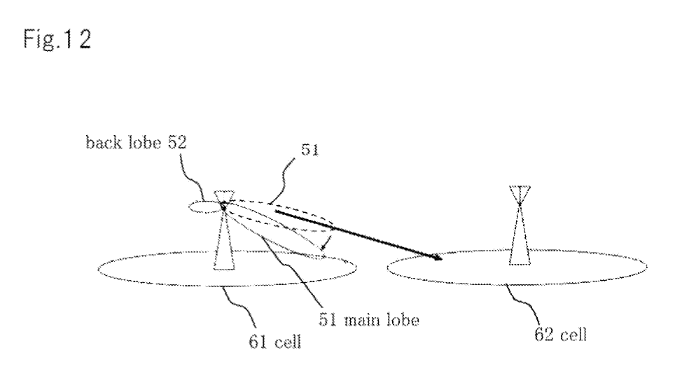

### BRIEF DESCRIPTION OF DRAWINGS

[FIGS. 1A and 1B] Diagrams each showing an example of an arrangement configuration of omni-antennas used for wireless communication by MIMO.

[FIG. 2] A diagram showing a result of simulating transmission capacity characteristics of a multi-antenna system shown in FIGS. 1A and 1B.

[FIG. 3] A diagram showing a configuration of a multi-antenna system according to an embodiment.

[FIG. 4] A top view showing an arrangement configuration of sector antennas according to the embodiment.

[FIG. 5] A diagram showing a state where the sector antennas are supported by support members according to the embodiment.

[FIG. 6] A diagram showing a result of simulating transmission capacity characteristics of the multi-antenna system according to the embodiment.

[FIG. 7] A graph showing a result of simulating transmission capacity characteristics when a beam width of a radio wave is changed in the multi-antenna system according to the embodiment.

[FIG. 8] A top view showing a multi-antenna system that includes two sector antennas according to an embodiment.

[FIG. 9] A top view showing a multi-antenna system that includes six sector antennas according to an embodiment.

[FIG. 10] A top view showing a multi-antenna system that includes eight sector antennas according to an embodiment.

[FIG. 11] A top view showing a multi-antenna system that includes twelve sector antennas according to an embodiment.

[FIG. 12] An explanatory schematic view showing over-reaching.

### DESCRIPTION OF EMBODIMENTS

Hereinafter, a multi-antenna system according to an embodiment of the present invention is described with reference to the drawings. The multi-antenna system according to the present invention can be used in place of a multi-antenna system of an omni-antenna system that performs wireless communication by MIMO.

FIG. 3 shows a configuration of the multi-antenna system according to the embodiment. The multi-antenna system according to the embodiment includes antenna device 10 and wireless base station device 20 connected to antenna device 10.

First, antenna device 10 is described. As shown in FIG. 3, antenna device 10 includes four sector antennas 11 for radiating antenna beams 30, supporting column 12 installed in a vertical direction (z-axis direction), and support members 13 projected from supporting column 12 to support sector antennas 11.

FIG. 4 is a top view showing an arrangement configuration of sector antennas 11. As shown in FIG. 4, four sector antennas 11 are arranged at equal intervals along circle 41 around supporting column 12 so that maximum radiation direction 31 where radiation intensity of a radio wave on a horizontal plane (xy plane) becomes maximum can be radially set from supporting column 12. A diameter φ of circle 41 is preferred to be long so as to reduce the correlation between radio waves radiated from sector antennas 11. However, in terms of installation places or costs for installation, a short diameter φ is preferred. For these reasons, the diameter φ is preferred to be set within a range of sizes twice to ten times as large as a wavelength of a radio wave radiated from each sector antenna 11. According to the embodiment, the diameter φ is about four times as large as the wavelength. Beam width 32 of the radio wave radiated from each sector antenna 11 is 120 degrees. The beam width is a measure of the spread of the radio wave based on the maximum radiation direction.

Each sector antenna 11 is supported by support member 13 in a state of tilting from the vertical direction so that maximum radiation direction 31 can be set in a depression-angle direction with respect to the horizontal plane. An angle θ of each sector antenna 11 with respect to the vertical direction (see FIG. 5) is set to enable suppression of radiation of antenna beam 30 outside the cell. Specifically, the angle θ is appropriately set within a range of 2 to 20 degrees.

Next, wireless base station device 20 is described. As shown in FIG. 3, wireless base station device 20 includes transmission unit 21 and control unit 22. In wireless base station device 20, control unit 22 generates a plurality of wireless signals different in data content. Specifically, control unit 22 transmits a plurality of wireless signals different in signal array. Control unit 22 also has a function of generating a plurality of similar wireless signals similar in data content. In this case, control unit 22 generates the wireless signals by space-time coding where a time dimension and a space dimension are coded. After signal generation, control unit 22 transmits the plurality of generated wireless signals to transmission unit 21. Under control of control unit 22, transmission unit 21 simultaneously transmits the plurality of wireless signals from control unit 22 individually to sector antennas 11. Then, sector antennas 11 simultaneously emit the plurality of wireless signals by antenna beams 30.

FIG. 6 shows a result of simulating transmission capacity characteristics of multi-antenna system 1. FIG. 6 shows the simulation result when a terminal (not shown) including two antennas receives antenna beam 30. In FIG. 6, angles 0, 90, 180, and −90 formed with respect to a center of the cell of multi-antenna system 1 are shown. In other words, in FIG. 6, a position in the cell corresponds to angle coordinates. In FIG. 6, a transmission capacity of 100% indicates, as in the case shown in FIG. 2, a theoretical limit value, namely, about 8.1 bps/Hz.

As can be understood from comparison of FIG. 6 with FIG. 2, multi-antenna system 1 has transmission capacity characteristics similar to those for wireless communication of the omni-cell system shown in FIG. 1. In other words, multi-antenna system 2 can create the wireless communication environment of the omni-cell system shown in FIG. 1 in a pseudo manner.

FIG. 7 is a graph showing a result of simulating transmission capacity characteristics when beam width 31 of angina beam 30 is changed in multi-antenna system 1. In FIG. 7, a horizontal axis indicates beam width 31 of antenna beam 30, and a vertical axis indicates a transmission capacity. In FIG. 7, a minimum value is a minimum value of a transmission capacity in the cell, and an average value is an average value among transmission capacities in the cell. As shown in FIG. 7, when beam width 31 becomes equal to or more than 120 degrees, multi-antenna system 1 exhibits transmission capacity characteristics similar to those for the wireless communication of the omni-cell system shown in FIG. 1.

According to the embodiment, the use of sector antenna 11 enables prevention of radio wave interference by mechanical tilting. Therefore, it is able to prevent radio wave interference with excellent cost performance and low antenna loss.

According to the present invention, the number of sector antennas 11 is not limited to four. Any number can be set as long as it is a plurality. FIG. 8 is a top view showing a multi-antenna system that includes two sector antennas 11 according to an embodiment. FIG. 9 is a top view showing a multi-antenna system that includes six sector antennas according to an embodiment. FIG. 10 is a top view showing a multi-antenna system that includes eight sector antennas according to an embodiment. FIG. 11 is a top view showing a multi-antenna system that includes twelve sector antennas according to an embodiment. The more sector antennas 111 cause small fluctuation of transmission capacity in the cell and large transmission capacity. However, the more sector antennas 11 cause cost increase and high power consumption. Thus, according to the present invention, the number of sector antennas 11 can appropriately be determined by taking these factors into account.

In FIGS. 8 to 11, support members 13 similar in structure are used for supporting sector antennas 11 (to reduce costs of support members 13), and hence sector antennas 11 are arranged at equal intervals along circle 41 around supporting column 12. However, each sector antenna 11 only needs to be disposed so that maximum radiation direction 31 can be radially set in the depression-angle direction from support column 12. Thus, each sector antenna 11 can be formed into a polygonal shape, representatively, an elliptic, square or rectangular shape.

According to the embodiment, as shown in FIG. 12, main lobe 51, which is a radio wave of the maximum radiation direction, is set in the depression-angle direction. This prevents main lobe 51 from reaching, over cell 61 of multi-antenna system 1, cell 62 adjacent to cell 61. In other words, overreaching is prevented. In this case, sector antenna 11 is a directional antenna, and hence back lobe 52 that is a radio wave opposite main lobe 51 is radiated in an elevation-angle direction. Radiation intensity of back lobe 52 is lower than that of main lobe 51, and thus there is little influence on the cell located in a radiation direction of back lobe 52. Specifically, it is preferable that sector antenna 11 exhibit characteristics where a FB (Front-to-Back) ratio calculated by the following expression (1) is 20 decibels or more.

FB ratio=20 log₁₀ (maximum value of main lobe/maximum value of back lobe) (1)

According to the embodiment, when supporting column 12 is made of metal, supporting column 12 is located behind sector antenna 11, and hence back lobe 52 is reflected by supporting column 12. As a result, the radiation intensity of back lobe 52 can be suppressed.

The embodiments of the present invention have been described. However, the embodiments are in no way limitative of the invention. Various changes and modifications understandable to those skilled in the art can be made of the configuration and the specifics of the present invention.

This application claims priority from Japanese Patent Application No. 2009-099867 filed Apr. 16, 2009, which is hereby incorporated by reference herein in its entirety.

### EXPLANATION OF REFERENCE NUMERALS

1 multi-antenna system

10 antenna device

11 sector antenna

12, 102 supporting column

13, 103 support member

20 wireless base station device

21 transmission unit

22 control unit

30, 201 antenna beam

31 maximum radiation direction

32 beam width

41, 301 circle

51 main lobe

52 back lobe

61, 62 cell

101 omni-antenna

1. An antenna device comprising:
a plurality of sector antennas arranged so that a maximum radiation direction where radiation intensity of a radio wave becomes maximum is radially set,
wherein the plurality of sector antennas simultaneously emit a plurality of wireless signals corresponding to one another.

2. The antenna device according to claim 1, further comprising support members for supporting the plurality of sector antennas in a state of tilting so that the maximum radiation direction is set in a depression-angle direction.

3. The antenna device according to claim 2, further comprising a supporting column to which the support members are fixed:
wherein the plurality of sector antennas are arranged along a circle having a diameter twice or more as large as a wavelength of the radio wave around the supporting column.

4. The antenna device according to claim 1, wherein the plurality of sector antennas are arranged at equal intervals.

5. The antenna device according to claim 1, wherein each of the plurality of sector antennas radiates a radio wave where a beam width on a horizontal plane of the plurality of sector antennas is equal to or more than. 120 degrees.

6. The antenna device according to claim 1, wherein each of the plurality of sector antennas has a FB ratio set equal to or more than 20 decibels.

7. The antenna device according to claim 3, wherein the supporting column is made of metal.

8. A multi-antenna system comprising:
the antenna device according to claim 1; and
a wireless base station device connected to the antenna device,
wherein the wireless base station device comprises a control unit configured to generate the plurality of wireless signals, and a transmission unit configured to simultaneously transmit, under control of the control unit, the plurality of wireless signals individually to the plurality of sector antennas.

9. The multi-antenna system according to claim 8, wherein the control unit generates the plurality of wireless signals different in data content or in signal array.

10. The multi-antenna system according to claim 8, wherein the control unit generates the wireless signals by space-time coding where a time dimension and a space dimension are coded.
